(19) United States
(12) Patent Application Publication
(10) Pub. No.: US 2010/0075595 A1
(43) Pub. Date: Mar. 25, 2010

(54) Dual Loop Active and Passive Repeater Antenna Isolation Improvement

(75) Inventors: Anthony DeMarco, Newport Beach, CA (US); Daniel Ray Ash, San Juan Capistrano, CA (US)

Correspondence Address: FISH & ASSOCIATES, PC;ROBERT D. FISH, 2603 Main Street, Suite 1000, Irvine, CA, 92614-6232, US

(73) Assignee: CELLYNX, INC., Mission Viejo, CA (US)

(21) Appl. No.: 12/425,615

(22) Filed: Apr. 17, 2009

Related U.S. Application Data
(60) Provisional application No. 61/045,662, filed on Apr. 17, 2008.

(51) Int. Cl. H04B 7/15

(52) U.S. Cl. 455/11.1

(57) ABSTRACT

A wireless repeater having dual cancellation loops is presented. A first cancellation loop is configured to remove an undesirable signal resulting from a design or manufacture of the repeater. A second cancellation is configured remove undesirable signals cause by a real-time changing environment where the repeater is deployed.

This application claims priority to provisional application 61/045662, filed Apr. 17, 2008 incorporated herein by reference in its entirety. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is wireless repeater technologies.

### BACKGROUND

The wireless systems that are deployed around the world for mobile telephony and mobile data will always be strained to deliver adequate service in all places users desire to have the wireless service.

A technique to improve the wireless service in a desired location that is autonomous to the wireless network called over-the-air repeater has been around since the beginning of wireless network deployments. Traditional components of an over-the-air repeater include a donor antenna, bi-directional amplifier, and a service or coverage antenna. Great care must be taken to ensure the placement of the two antennas is such that the gain in the bi-directional amplifier is less than the isolation measured in dB between the two antennas.

For typical repeater installations the vertical and horizontal spacing of the two antennas is significant in that it requires the physical mounting of the antennas in different locations and the routing of feeder cables to complete the circuit to the bi-directional amplifier. It is generally accepted that the installation of traditional repeaters is beyond what could be reasonably expected from the average consumer.

The goal to have a repeater product that is compatible with the average consumer has stimulated this novel approach to use readily available technology and low cost components in use today for other applications such as wireless base stations to eliminate the requirement for individual antennas and the spacing there of.

This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for wireless repeaters having antennas that are positionally independent with respect to each other.

### SUMMARY OF THE INVENTION

The inventive subject matter provides apparatus, systems and methods in which a wireless repeater comprises a dual cancellation loops that allows for placing two antennas relative to each other irrespective of gain.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a dual loop repeater.

### DETAILED DESCRIPTION

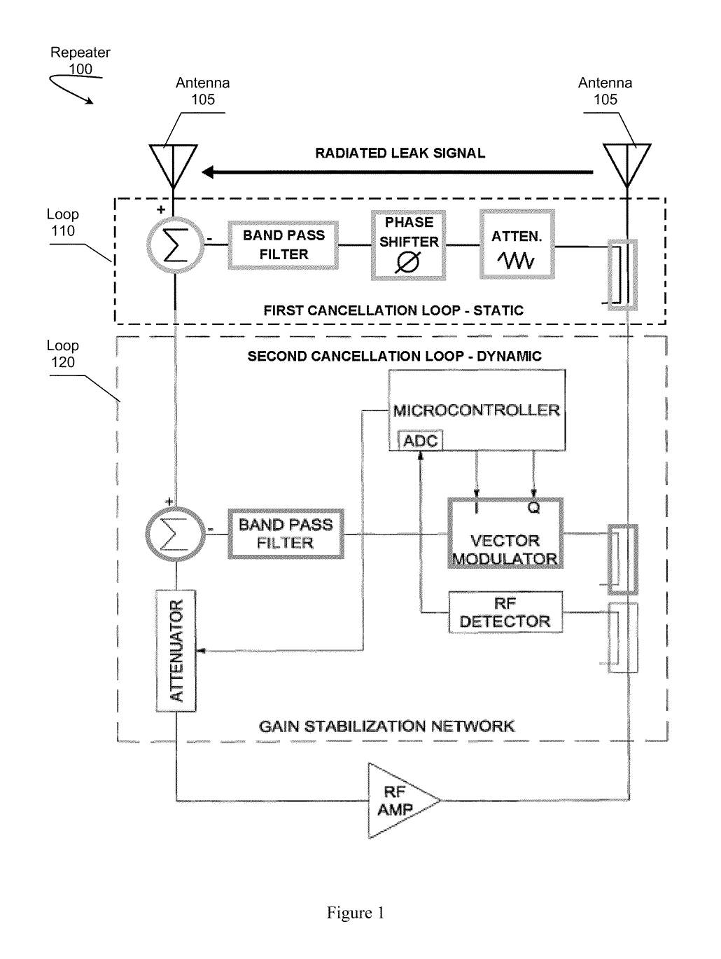

In FIG. 1, repeater 100 represents one possible embodiment of a dual loop repeater having at least two antennas 105 and comprising loop 110 configured to cancel a feedback due to a design/manufacture signal leakage, and loop 120 configured to cancel environment induced signal reflections. Loop 110 is preferably adapted to have a static configuration that does not change in real time. Loop 120 is preferably adapted to be dynamic, and to respond in real-time to changes in signal reflections, or other undesirable signals, in a deployed environment.

Various embodiments of the disclosed inventive subject matter can provide at least adequate performance of a wireless repeater with realistic antenna isolation, achieved with antennas placed very close to the bi-directional amplifier to eliminate the requirement for an installation of antennas with the spacing required with legacy repeaters.

One aspect of the inventive subject matter involves cost effectively eliminating adverse affects of the boosted signal feedback to the input of the bi-directional amplifier. The feedback cancellation loops in such an embodiment address the real world sources of the boosted signal arriving at the input of the bi-directional amplifier. The sources can be categorized in two areas; 1) design/manufactured leakage and 2) environment induced reflections.

The design/manufactured leakage refers to a signal feedback path that remains relatively constant over time and allows for a relatively static cancellation circuit, loop 110, to introduce an inverse signal at the input of the bi-directional amplifier to essentially cancel out the leaked signal before any harmful interactions with the bi-directional amplifier. The parameters of the loop 110 circuit are static, and are not adjusted in real time. The configuration parameters are preferably set once at the time of manufacture, or possibly set periodically manually (e.g., through a web interface, a firmware upload, a manual reset, etc.) through the life of the repeater.

The environment induced reflections refers to a signal feedback path that changes relatively constant over time and requires a relatively fast and dynamic cancellation circuit, loop 120, to introduce an inverse signal at the input of the bi-directional amplifier to essentially cancel out the environment induced signal before any harmful interactions with the bi-directional amplifier. The loop 120 circuit is adjusted in or near real time and is meant to constantly adapt the repeater to the current conditions for optimum stable performance. With the additions of loops 110 and 120, adequate performance of a repeater with the antennas placed in close proximity of the bi-directional amplifier can be achieved where adequate performance is measured by placing the repeater near an area where wireless service is desired but not present without the repeater and present with the repeater.

In some embodiments a single loop similar to loop 120 above can be used to cancel both leaked signal and environmentally induced signals.

Thus, specific embodiments and applications of the inventive subject matter have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A wireless repeater comprising
a first and a second antenna;
a first cancellation loop coupled to the first and the second antenna;
a second cancellation loop coupled to the first and the second antenna; and
wherein the first and the second cancellation loops allow for placing the antennas relative to each other irrespective of gain.

2. The repeater of claim 1, further comprising a bi-directional amplifier coupling the first and the second antenna.

3. The repeater of claim 1, wherein the first loop is configured to cancel a leak signal.

4. The repeater of claim 1, wherein the second loop is configured to cancel an environmentally induced signal.

5. The repeater of claim 4, wherein the second loop is configured to adapt in real-time to environmental conditions.
